(19) United States
(12) Patent Application Publication
(10) Pub. No.: US 2018/0018598 A1
(43) Pub. Date: Jan. 18, 2018

(54) SYSTEM AND METHOD FOR PROVIDING A TERTIARY MARKET FOR USED TICKETS

(71) Applicant: Fliptix, LLC, Pelham Manor, NY (US)

(72) Inventor: Seth Siegel, Pelham Manor, NY (US)

(21) Appl. No.: 15/718,146

(22) Filed: Sep. 28, 2017

Related U.S. Application Data
(63) Continuation-in-part of application No. PCT/US2017/028500, filed on Apr. 20, 2017.
(60) Provisional application No. 62/327,365, filed on Apr. 25, 2016.

(51) Int. Cl. G06Q 10/02; G06Q 20/10; G06Q 30/06; H04W 4/02

(52) U.S. Cl. CPC G06Q 10/02; G06Q 30/0613; G06Q 20/10; H04W 4/021

(57) ABSTRACT

A system and method for the sale, purchase, and reuse of tickets previously purchased is provided. The system and method provide a tertiary market for used ticket by enabling the tickets of “early exits” to be resold to later attendees who wish to attend the remaining duration of the event. The system and method can be applied to any event in which tickets or passes of some sort are sold, both single-day and multi-day, including but not limited to: sporting events; concerts; festivals; and conferences. Tickets are made available through an electronic system that captures the ticket information either upon departure, or soon after. Upon recapture, tickets are then made available to a new consumer through the same process.

This application is a continuation-in-part of PCT/US2017/28500, filed Apr. 20, 2017, which claims priority to U.S. Provisional Application Ser. No. 62/327,365, filed Apr. 25, 2016, the entire disclosures of which are hereby incorporated by reference.

### FIELD OF THE INVENTION

The field of the invention relates to event ticketing, and computer implemented methods for implementing the same.

### BACKGROUND OF THE INVENTION

Events such as sports, concerts, and business conferences provide myriad revenue opportunities to the parties involved. These parties include performers, managers, booking agents, promoters, and venues. Sources of revenue above and beyond the revenue from the primary marketing ticket sales may include advertising revenue, concessions, and merchandising.

Early exits of attendees from venues represent lost revenue, both in the form of decreased advertising impressions as well as concessions and merchandising revenue. Given this decline in revenue per seat, it is in the interest of all parties within the ticketing ecosystem to keep seat filled as long as possible.

The traditional way that venues specifically and events more generally have maximized seat time is through promotions before and after the event. One example is after-game fireworks common at many minor and even major league baseball games

However, when an attendee exits early, there is no current way in order for that “lost” seat revenue to be reclaimed. The advertising impressions and concessions sales walk out the door with them.

### SUMMARY OF THE INVENTION

Various methods and systems for selling new event tickets are known in the art. The secondary ticket market is rife with many entities that offer the ability for ticket owners to sell their tickets to other people before an event is over. This practice is sometimes referred to as “scalping” when the resale ticket price is higher than the original cost of the ticket. StubHub, RazorGator and Vivid Seats are all examples of sources for ticket resales. However, these ticket resellers have one thing in common—they sell tickets before they have been used. Tickets refer to something that provides a customer access to an event venue, for example physical printed tickets, wristbands, QR codes, barcodes, RFID, or RF.

An event ticket is actually just a license to use a seat. Once a patron exits a venue, the promoter considers the use license as terminated, as reentry is typically not allowed at events. There are multi-day events, such as music festivals or sports tournaments where patrons can purchase multi-day passes that allow for reentry, but those passes cannot be legitimately transferred to a different user. When patrons exit a venue after using their ticket, the space or seat that they occupied generally goes unused for the remainder of the event. There are options for upgrades that may be offered where a vacated seat would provide preferred locations to those already in the venue, however, those options all require that upgrades only be available to patrons that are already in the venue and therefore already had an entry ticket into the venue. None of these prior art offerings provide a legitimate path to fill space and seats that have been vacated with patrons that are not in the venue, and did not have tickets to enter the venue.

Opportunities for significant revenue are lost because the vacated seats and spaces go unused for the remainder of an event. Promoters and venue operators miss significant revenue from concession and merchandise sales that would be generated if those vacated seats and spaces were filled. This highlights a major problem with current ticket upgrade platforms—moving patrons that are already in a venue to better seats does not drive any additional sales of concessions or merchandise. Promoters and ticketing companies also miss substantial revenue opportunities from a failure to sell to a pent-up market demand for access to sold out events. Embodiments of the present invention described herein address the failures of the known platforms and prior art and provide a solution through a system and method for enabling the sale of vacated seats and space to patrons that are not currently in the venue. Embodiments of the present invention described herein provide a path to increased revenues, increased fan engagement, and increased demand for events where there is currently no solution to allow for a viable market for the resale of previously used seats or space.

Further opportunities for significant revenue generation comes from the ability to serve targeted advertising to departing patrons based upon GPS tracking. By tracking where patrons that participate in the system of the present invention described herein go after they have departed an event venue, advertising can be directed to the individual patron. Additionally, advertising can be directed at groups of patrons remaining in the venue, based upon the location data collected from departed patrons.

In accordance with various embodiments of the present invention, this missed revenue can be captured through the creation of a system and method which provides a market for the resale of previously seats and space at an event, while that event is still in process. These resales happen during the course of an event, allowing promoters and the venue to generate significant missed revenue. Seat and space resales create new ticket revenue, as well as new revenue in the form of concessions, merchandising, and advertising events. It also provides a strategy for venues and events to effectively oversell sold-out events, exceeding previous revenue limitations.

In accordance with a first embodiment of the present invention, a system and method is provided which, upon the departure of a ticket holder from an event while the event is in progress, provides for the resale of the vacated seat or space to a third party for the remainder of the event. The departure of the ticket holder may be through both passive and active means. Passive is defined as the act of leaving an event for any reason other than receiving an inducement to exit the event early. Active is defined as the act of leaving an event for an inducement to exit. The inducement may be a monetary payment or non-monetary item whose offering is a cause for exiting an event prior to event completion.

The system tracks when a ticket holder has left an event for the purposes of creating the ability to resell the previously occupied seat or space before the completion of the aforementioned event. The system may use manual or automated processes to capture the exit information. The system may use technology such as GPS or other location tools to verify the location of a patron that has left a venue, so as to ensure the integrity of the overall system. When the exit data is captured a third party will have the ability to purchase a ticket for the previously occupied seat or space.

The original ticket holder may be offered an inducement to leave an event early (“active exit”). The inducement may come from the use of the system to specify either a monetary or monetary equivalent that the original ticket holder will be willing to accept to exit an event before the completion of said event. Inducements may be varied through various incentive programs to promote, for example, donations to an alumni association, or to receive a credit for a future purchase, although other incentive programs are certainly envisioned.

A potential buyer that is interested in purchasing a ticket to an event for a previously occupied seat or space may have various options to view and purchase the inventory that has been made available by the exit of the original ticket holder. Those options, which can be defined by the system, may include the ability to offer a price for specific seating sections prior to inventory having been made available; paying a fixed fee for inventory that has become available; paying a dynamically adjusting fee based on a predefined algorithm, or bidding on inventory that may become available. The purchaser of a ticket to use the previously occupied seat or space will present a newly issued ticket to gain entry to the event prior to completion of the event. The new ticket may be in the form of a physical ticket, for example like a wristband or other printed ticket, or through electronic means, for example through a bar code, QR code, RF signal or other electronic means that is readable by an electronic reader.

In accordance with a second embodiment of the present invention, a system and method is provided which, upon the departure of a ticket holder from an event that allows reentry while the event is in progress, allows for the resale of the ticket to a third party while the event is in progress. In particular, the system tracks when the ticket holder has left the event, and thereafter allows the ticket to be resold to a third party. Preferably, the system allows a ticketholder leaving an event in progress to offer their ticket for the remaining portion of the event for resale through the use of a software application accessible through a mobile device such as a smart phone, tablet, or watch. When the ticket holder leaves the venue, the resold ticket becomes valid for entry, or a new ticket is issued in place of the original ticket. A potential buyer can choose to purchase the ticket using their mobile device, and obtain an electronic ticket which allows entry into the event, or the original physical ticket may be transferred. Also provided are computer readable media, having stored thereon, computer executable process steps operable to control a computer or computers to perform the methods described herein.

The system and method in accordance with the various embodiments described herein may provide an additional source of value to venues. In order to provide analytics regarding sales and purchases of tickets and vacated seats or space, in certain embodiments of the present invention, the system and method captures data about departures including when as well as why and to where early departures are leaving. Understanding why and when people are leaving provides venues useful insights to help them consider improvements to encourage attendees to stay longer. Additionally, knowing to where attendees go next after an event provides myriad opportunities for affiliate marketing, partnerships, co-branding, and advertising. For some events, especially multi-day events, tracking departures also allows venues to sell “vacated inventory” (i.e., no longer used seats/passes).

In accordance with a third embodiment of the present invention, a computerized method for providing a market for resale of vacated seats or space at a venue upon the departure of a ticket holder from an event while the event is in progress at a venue, the method comprises, using one or more computers: electronically tracking when the original ticket holder has left the event; electronically offering a ticket to the vacated seat or space to a third party; electronically processing the sale of the ticket for access to the vacated seat or space; electronically transmitting to the third party a ticket to access the vacated seat or space while the event is still in progress; and electronically transmitting to the venue a record of the transaction. Computer readable media may also be provided, having stored thereon, computer executable process steps sufficient to control one or more computers to provide a market for resale of vacated seats and spaces upon the departure of a ticket holder from an event while the event is in progress at a venue by performing the steps of the method of the third embodiment.

In accordance with a fourth embodiment of the present invention, a system for providing a market for resale of vacated seats and spaces upon the departure of a ticket holder from an event while the event is in progress comprising a server, the server receiving a notification that the ticket holder has left the event; and in response to said notification, transmitting an offer to sell a ticket for that vacated seat or space to a plurality of mobile apps executing on respective mobile devices of a plurality of prospective buyers; the server receiving a request to purchase the ticket from at least one of the plurality of mobile apps, the server electronically processing the resale of the ticket; the server transmitting to said one mobile app a resale ticket and electronically transmitting to the venue a record of the resale ticket.

In accordance with a further embodiment of the present invention, a system and method is provided which, upon the departure of a ticket holder from an event, the location of the ticket holder is tracked so as to gather information regarding where event attendees are likely to go after departing the event. In particular, the system uploads the location information of the departed ticket holder to a server. Based upon the data collected from one or more departed ticket holders, the system directs advertising to event attendees that are still in attendance at the event. Also provided are computer readable media, having stored thereon, computer executable process steps operable to control a computer or computers to perform the methods described herein.

In accordance with further variants of the embodiments described above, the following steps may be provided, alone or in any combination in accordance with the computerized method, the system, and/or computer readable media:

wherein potential buyers are provided with a non-activated wristband tickets prior to the event, and such non-activated wristband tickets are activated remotely upon the purchase of previously vacated seats or space;

wherein the step of electronically tracking comprises scanning, at an exit of the venue, the ticket, with a hand-held scanning device or scanning kiosk;

wherein the step of electronically tracking comprises tracking with a geolocation system, the geolocation system being one of a geofencing system, a GPS system, and a beacon system;

wherein the step of electronically offering the ticket for resale further comprises the ticket holder offering the ticket for resale using a hand-held computing device;

wherein the handheld computing device and/or hand-held scanning device is a mobile phone, a watch, or a tablet;

wherein the step of electronically offering includes receiving, at a server, information from the handheld device sufficient to indicate the offer for resale and transmitting, from the server, the offer for resale to a plurality of users; and the step of electronically processing includes receiving, from one of the plurality of users, information sufficient to process the resale of the ticket;

wherein the plurality of users may be ranked based on any number of criteria, including, but not limited to time of registration, membership at a premium level, loyalty incentive program or other rankings, such that the offers for resale will be made to different groups within the plurality of users at different times;

wherein the price for resale may be set utilizing an algorithm that considers factors including at least one of the current weather at the venue, the current score of the event, and the upcoming performers;

wherein prior to the electronically offering step, the method includes prompting the original ticket holder to resell their seat or space and receiving authorization to resell the seat or space;

wherein when a purchase is completed by one of the plurality of users, the original ticket for the seat or space is deactivated or otherwise indicated in the event ticketing system as no longer being valid for entry to the venue; and/or

wherein the step of transmitting to the third party further includes transmitting a scannable barcode image of the resale ticket to the third party.

### BRIEF DESCRIPTION OF THE DRAWINGS

Various embodiments of the present invention are described below by reference to the following drawings, in which:

FIG. 1 is a schematic diagram showing the components of the desired system including a mobile application, a web site, the internet, and a back end system including a ticket transaction server and a user database;

FIG. 2 is a schematic diagram showing a ticket holder and late arriver connected through the software application;

FIG. 3 is a schematic diagram showing that while inside the venue, the ticket holder has ownership of the ticket information;

FIG. 4 is a schematic diagram showing that upon or prior to exit of the venue, the ticket holder will provide ticket information to the software application;

FIG. 5 is a schematic diagram showing that shows that once the ticket holder leaves the venue, the software application will have ownership of the ticket information;

FIG. 6 is a schematic diagram that shows how the late arrival is able to search for available tickets inside the software application;

FIG. 7 is a schematic diagram that shows the software application sending a push notification to the late arriver of tickets representing vacated seats or space available for events they may be interested in;

FIG. 8 is a schematic diagram that shows the late arriver purchasing a ticket for the previously used seat or space from within the software application;

FIG. 9 is a schematic diagram that shows that at the venue gate, the gate staff verifying the purchase of the ticket;

FIG. 10 is a schematic diagram that shows that the ticket information will belong to the late arriver;

FIG. 11A illustrates a screen display with which users create an account via a web site;

FIG. 11B illustrates a screen display with which users create an account on via a mobile device;

FIG. 11C illustrates a screen display on a phone or other mobile device showing a potential “late arrival” being notified of an event that meets her/his preferences;

FIG. 11D illustrates a screen display on a phone or other mobile device showing a likely “early exit” being asked to confirm if they did in fact leave;

FIG. 11E illustrates a screen display on a phone or other mobile device showing events being recommended to a user;

FIG. 11F illustrates a screen display on a phone or other mobile device showing an alert that an event is coming up that may be of interest to a user;

FIG. 11G illustrates a screen display on a phone or other mobile device showing an alert to a potential active seller to ask how much they might be induced to sell their ticket for; and

FIGS. 12(a) through 12(d) are flow charts which illustrates process steps in accordance with embodiments of the present invention.

### DETAILED DESCRIPTION

The process, methods, and systems in accordance with various embodiments of the present invention create a tertiary market for previously occupied seats and space. In accordance with these embodiments, a method is provided for selling tickets for seats and space that have been previously be occupied. A ticket is sold when a seller (an “early exit”) who may intend to leave, or already has left a venue early, so notifies the system, so that a buyer (the “later arriver”), who is interested in attending the event for the remaining duration of the event, can make a purchase of the right to use the previously occupied seat or space.

Preferably, but not necessarily, several operating assumptions may include: (i) tickets for previously used seats or space sold through system are not resold for more than the face value of the original ticket; and, (ii) it is expected that some potential buyers may choose to purchase tickets for previously used seats or space for a portion of an event instead of purchasing other tickets available through the primary or secondary resale markets—i.e., some consumers will accept missing a portion of an event rather than paying inflated resale prices for unused tickets.

Data and analytics about the motivations, timing, and destination of those who leave early may be of value to venues, promoters, and artists. Presently events, venues, and conferences may have difficulty tracking when attendees leave events despite the commercial value of such information.

In accordance with an embodiment of the present invention, a computerized method is provided for providing a tertiary market for resale of a previously occupied seat or space upon the departure of an original ticket holder from an event while the event is in progress at a venue, as well as a computerized system for implementing this method. The method includes electronically tracking when the original ticket holder has left the event; preferably electronically communicating with the original ticket holder to confirm exit; electronically offering a ticket for the previously occupied seat or space to a third party that is not in the venue; electronically processing the sale of the ticket for the previously occupied seat or space; electronically transmitting to the third party a ticket; and electronically transmitting to the venue a record of the ticket for the use of the previously occupied seat or space. In this regard, the step of electronically tracking may further comprise scanning, at an exit of the venue, the original ticket, with a hand-held device (such as a hand-held scanner held by a gate attendant) or at a scanning kiosk located at the venue exit. The step of electronically tracking may alternatively or further comprise the use of geolocation technologies such as but not limited to GPS, Beacons, ibeacon™ location and proximity detection technology, and other networked and static systems for identifying location of both the original ticket holder and a third party. The step of electronically offering a ticket for the resale of the right to occupy a previously vacated seat or space may further comprise the original ticket holder offering their occupied seat or space for resale using a hand-held device such as a mobile phone, a watch, or a tablet. The step of electronically processing the resale of the right to occupy a previously vacated seat or space may further comprise receiving, at a server, information from the original ticket holder's handheld device sufficient to indicate the offer for resale, transmitting, from the server, the offer for resale to a plurality of third party users (e.g., to a user's mobile phone); and receiving, from one of the plurality of third party users, information sufficient to process the resale of the right to occupy a previously vacated seat or space.

Embodiments of the subject matter described herein may be implemented in digital electronic circuitry, or in computer software, firmware, or hardware, or in combinations of one or more of them. Embodiments of the subject matter described herein can be implemented as one or more computer programs, for example, one or more modules of computer program instructions, encoded on computer storage medium for execution by, or to control the operation of, data processing apparatus. A computer storage medium can for example, be, or be included in, a computer-readable storage device, a computer-readable storage substrate, a random or serial access memory array or device, or a combination of one or more of them.

The process steps and operations described herein can be implemented as operations performed by a data processing apparatus on data stored on one or more computer-readable storage devices or received from other sources. As used herein, “data processing apparatus” encompasses all kinds of apparatus, devices, and machines for processing data, including by way of example a programmable processor, a computer, a system on a chip, or multiple ones, or combinations thereof. The apparatus can include, or even consist of, special purpose logic circuitry, e.g., an FPGA (field programmable gate array), state machines, sequencers, or an ASIC (application-specific integrated circuit).

A computer program (for example, a program, software, software application, application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. As used herein, the term “app” or “mobile app” is meant broadly to include, for example, an executable binary that is installed and runs on a mobile device, or a web site that the user navigates to within a web browser on the mobile device, or a combination of them. An “app” may also refer to multiple executable binaries that work in conjunction on a mobile device to perform one or more functions; for example, an Android™ service and an Android™ application that communicate with one another.

The process steps described herein can be performed by one or more programmable processors executing one or more computer programs to perform actions by operating on input data and generating output. The processes can also be performed by, and apparatus can also be implemented as, special purpose logic circuitry, e.g., an FPGA (field programmable gate array), a sequencer, a state machine, or an ASIC (application-specific integrated circuit).

### User Experience

The various embodiments of the present invention can be viewed from the perspective of the late-arrival ticket holder/buyer and from the perspective of the early-leaver ticket holder/seller.

### “Late Arrival” Ticket Holder User Experience

The “late arrival” ticket buyer is a fundamental user of the process described herein. The “late arrival” may introduce new value into the ticket and event ecosystem by 1) buying the unwanted/unused time from the “early exit”, 2) buying additional concessions or merchandise the “early leaver” would not have otherwise bought, 3) exposing themselves to advertising impressions, and, 4) paying fees to participate in the ecosystem.

The late arrival may be a person who: (i) values a ticket or a certain class of tickets in the event highly enough that they choose not to buy tickets available at face value (primary market) or above face value (secondary resale market), instead trading time for seat preference; (ii) is making an impulse purchase based on factors such as proximity (i.e., they are near the arena) and/or interest (e.g., a close game); (iii) wanted to attend an event but, was closed out due to a sold out situation, and/or (iv) is issued an invitation to attend the event based on factors such as proximity and user interest

In each of these scenarios, the late arrival ticket holder's interest in an event does not end once an event begins and he/she is willing to enter an event after it has started.

In accordance with various embodiments of the present invention, the late arrival user may indicate his/her interest in an event in a number of ways.

For example, the late arrival user may indicate interest in various events or classes or types of events as part of their user-profile when they initially register on the system, for example by entering registration data into the system over the internet from a computer, smart phone, tablet or other computing device. The profile can later be updated by the user in the same manner to indicate interest in different or additional events or classes or types of events.

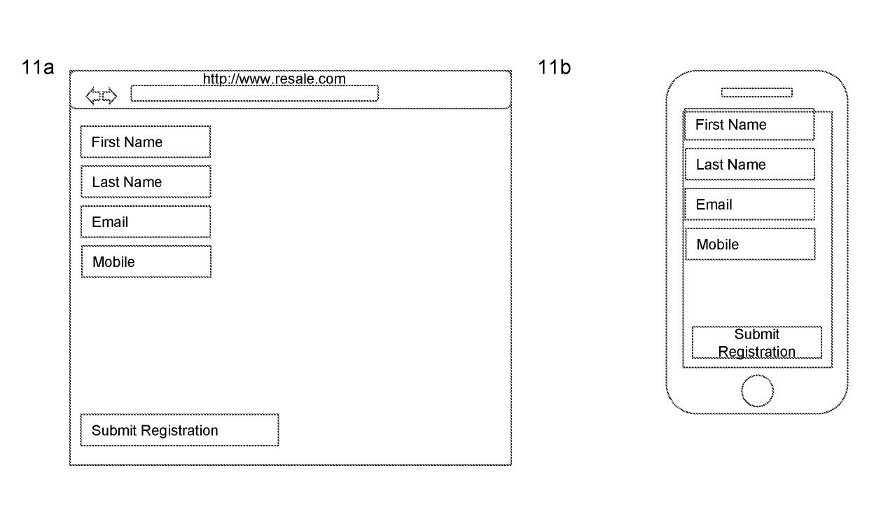

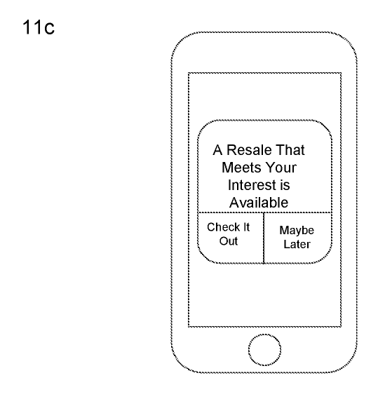

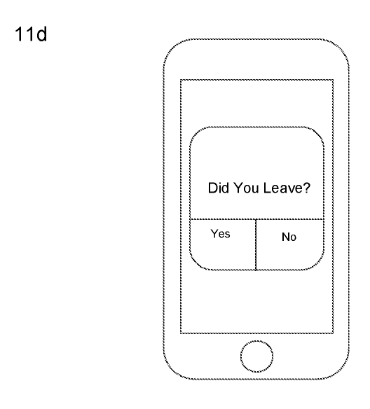

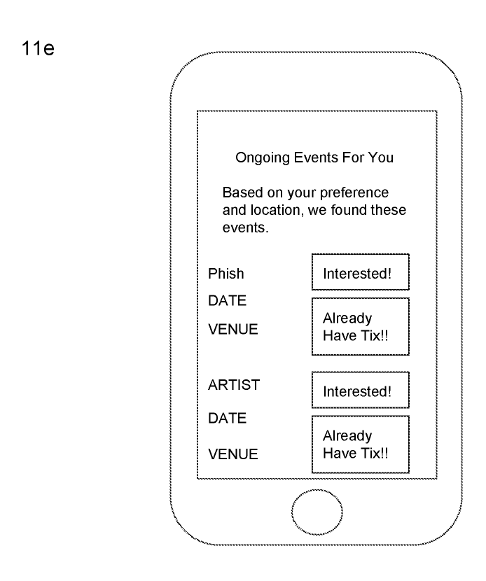

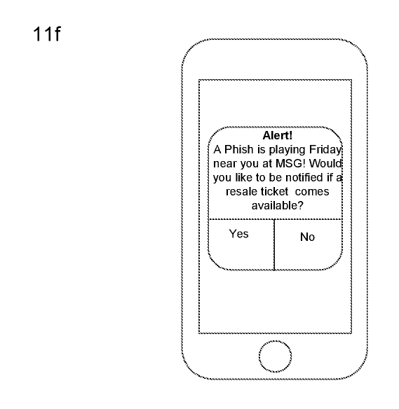

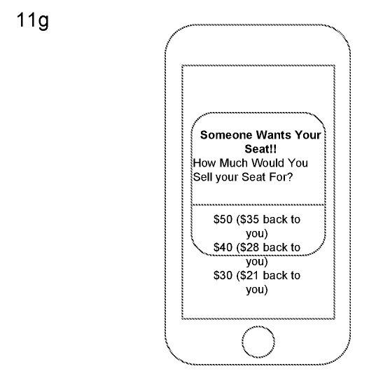

The late-arrival user may have tried to acquire tickets to an event from the primary ticket source, only to learn that the event was sold out. The user may then be directed to connect with the system of the current invention to register as a person that is interested in that specific event, should seats or space become vacated. The system of the current invention would provide a path for the user to attend an event that has already commenced, as an alternative to having to pay secondary market prices for original tickets, which are often much higher than face value of the original ticket. The system server may also notify the user of vacated seats or space at that event, either through the mobile app or via a text message as illustrated in FIG. 11F.

The late-arrival user may also or alternatively be notified by the system of an event. For example, a data processing device such as a system server may transmit notifications of events to the late-arrival user via a mobile app on the late-arrival users smart phone, tablet, or other computing device, via text message, or via email. For example, the mobile app could display upcoming events on the display screen of the user's phone as illustrated in FIG. 11E, and the user could respond by clicking (or otherwise entering via the phone interface) “interested”, and this interest would then be transmitted via the mobile app to the system server. The system server may also notify the user of an individual event prior to the event, either through the mobile app or via a text message as illustrated in FIG. 11F. In this example, the user can indicate interest, for example by clicking (entering) “Yes.” The user may also search through a listing of events in geographic proximity to late arrival's current location either via the mobile app or on a website.

In certain embodiments, prospective “late arrivals” use a mobile app, system web-site, or other application to select local events that they'd like to attend, optionally coupled with information such as preferred music genres, bands, and sports teams. This preferred event information is stored in a user profile data store with the system and is optionally used as an input to the algorithm used to suggest events. As an example, a system website, for example as illustrated in FIG. 11A, may prompt the user to enter data into data fields such as name, username, password, email, mobile phone number, payment information, preferred music genres, bands, and sports teams. This data can be entered in any conventional manner, such as through key entry, radio boxes, drop down menus, and the like. The user would then submit the registration, for example, by clicking on a “submit registration” button. The data can also be entered via a mobile app in the same manner as illustrated in FIG. 11B.

Based on these user preferences, the system, for example via an application(s) on the system server, will propose a list of current and upcoming events that are happening within a user defined radius of his/her current location, and transmit that information to the user via a mobile app, email, and/or text.

Further, using the notifications functionality of both iOS and Android subsystems, users may also elect to be notified of events that meet their specific criteria (time range, distance, and event type). The application may utilize current and future geolocation technologies including GPS, beacons, etc.

For example, when a ticket for a vacated seat or space becomes available, a push notification through services including SMS, Email, Instant Message, Direct Message, etc. can be sent to the mobile device of a potential late arrival through the mobile app. Alternatively, such notification could be pushed to a mobile device of a late arriver, without regard for whether a mobile app has been installed on the mobile device. When the push notification is received, the late arriver can purchase the ticket through the mobile app and the ticket is made valid for their entry. Alternatively, the push notification could, for example, include a URL link to a system website which, in turn, will prompt the user to enter information sufficient to purchase the ticket.

When the late arriver arrives at the venue, they will utilize use their mobile device to enter. Their valid ticket can be captured, for example, through UPC, RFID, or NFC communications through an electronic scanner as they enter. Alternatively, the late arriver may have received a previously unenabled RFID enabled wristband, in which case at the time of purchase, the RFID wristband would be enabled, and the RFID wristband possessed by the original ticket holder would be deactivated.

The process, methods and system of the present invention may use integration with the venue or promoter or event's access control or ticketing system to ensure the validity of the ticket. In other words, the system may validate the validity of the original ticket through communication with the venue, the issuer of the original ticket, or their agents and partners.

### “Early Exit” Ticket Holder User Experience

The early exit ticket holder is the source of tickets for the late arrival ticket holder. Ticket inventory available for purchase by “late arrivals” can be made available through a number of methods.

As an “early exit” ticket holder leaves an event in progress, he or she may scan out at an electronic kiosk or via an exit RFID or NFC scanner. The “early leaver” will scan her/his ticket upon exit at a kiosk or scanner that will enter their ticket into the system. These kiosks may be located outside of the secured area where incoming tickets are scanned. Once the early leaver scans out, the system can immediately make available a ticket to the event in progress.

The “early exit” ticket holder can also be identified through any geolocation technology such as Venue or Event's access control system or GPS, beacons, and the like to record the exit. The early leaver may also be asked to confirm their exit, for example, via a mobile app on a mobile device such as a phone or tablet.

The exit of the early exit ticket holder can also be identified implicitly as ticket exit data scanned through UPC, RFID, or NFC communications.

The early exit ticket holder can also be identified shortly after an “early exit” leaves an event. This can be done, for example, via geolocation technology establishing location or “early exit” and a notification sent via the mobile app asking an “early exit” if they have left an event.

The system described herein allows venues to make or use any or all of the above methods of making ticket inventory available for purchase by “late arrivals”.

As outlined above, one scenario is for “early exits” to explicitly indicate their departure through active means when they leave the arena. This approach may minimize the time between departure and the availability of a ticket for sale based on a vacated seat or space. It also provides an opportunity to capture the departure event, as well as, optionally, some information about why and to where the early exits are going.

The system and process additionally enables passive recapture of seat and space inventory through tracking exits. Passive exits, in some cases based on various venue and market conditions, may not be compensated for subsequent sales of their used tickets. The aggregate preferred embodiments allow early exits to leave the arena—i.e., passive exits—through means such as NFC (Near Field Communication), RFID ID, and location based services.

In accordance with certain embodiments of the present invention, the system provides rewards to the early exit ticket holders in order to induce them to make tickets available.

The early exit ticket holder may have his ticket registered in the system in a number of ways. For example, as part of the ticket purchase process, the user can register with the system or provide their username and password so that the purchased ticket is associated with their email address and/or cell phone number so that they can actively participate in the system and obtain rewards. An early exit ticket holder may be provided with a downstream incentive to encourage registration at the time of purchase, such as increased revenue sharing possibilities, or bonus loyaty rewards. However, it is also possible for a venue to recapture tickets when a ticketholder leaves a venue with a no re-entry policy (either actively, for example, by scanning by a gate agent, or passively, for example via geolocation technologies) and resell the vacated seat or space without the knowledge or participation of the early exit ticket holder.

Reward options and inducements made possible through the systems and processes may include, but are not limited to: (i) credited “event time” that may be stored for use towards future events or tickets; (ii) “points” that can be redeemed towards the purchase of merchandise or exclusive offers (which has the potential to increase revenue for the venue and/or system provider); (iii) cash refund for partial unused time; (iv) special offers from third parties; and (v) donations made to charitable organizations.

Finally, the system may provide the option for the user to set a desired cash price for sale of their vacated seat or spacethrough the system. For example, a potential early exit ticket holder may indicate through the mobile app that he or she is willing to leave the venue and make the seat or space available for $15.00. The system could then, for example charge a processing fee to the late arrival user (for example $2.00).

### System Overview

In accordance with a preferred embodiment of the present invention, the components of the system include a mobile app, a web site, the internet, a back-end server system in which user information is stored and transaction processing occurs at least in part, and a ticketing system server, which may or may not function, at least in part, as the transaction processing server.

Following discovery by consumers of the application a new user registers. Registration can be implemented in a number of ways. For example, a user can register on a web site, accessed through a computer or mobile device (FIG. 11A). Alternatively, after downloading the application from locations such as the iTunes™ store for iOS™ devices or Google Play™ for Android™ devices (FIG. 11B).

In a preferred embodiment, during registration, users provide some or all of the following information:

Data to Create an Account:

a. Email

b. Password

c. Users may also be provided with the option to authenticate via OAuth providers accessed by the system via mechanisms such as RESTful APIs and secure HTTP.

Demographic Data

a. Name

b. Street Address

c. City and State

d. Zip

e. Mobile Phone

Communications Preferences

a. Opt-in—Text

b. Opt-in—Email

Optional Profile Information

a. Default Payment Type

b. Event Type Preferences

c. Arena Preferences

d. Favorite Sports and Teams

e. Music Preferences

f. Season ticket ownership

g. Geographic Tolerance Threshold

Notification Types and Method [Alters, Banner, Email, Text]

a. Upcoming event

b. Buy opportunity during event

c. Sell opportunity during event

Intended Uses (Users May Select Both)

a. Buyer (the user intends to be a “late arriver” who will buy used tickets)

b. Seller (the user intends to be an “early exit” who will sell used ticket)

### Pre-Event

The embodiments allow the system to track interest in both selling and buying tickets for vacated seats or space.

In a set interval, for example between seven and one day(s), before an event, the system, in its role of market maker, estimates potential buyer (late arrival) and seller (early exit) interest based on explicit interest through the application, and heuristics based on user profile data. This data becomes 1) an input to pricing and 2) is used to prompt sellers and buyer during the event itself with customized notifications.

As illustrated in FIG. 11E, the same screen may be used to both collect potential buying interest as well as to record those users who already hold tickets, and hence may be potential sellers. This data can be used to estimate potential buyer (late arrival) and seller (early exit) interest using conventional statistical methods.

The system, in its role of market maker, allows users to register interest of attendance and at what price, prior to the event start.

### In-Event

During an event, registered users who have also identified themselves as ticket holders may be prompted with reminders, through notifications wirelessly transmitted to their wireless devices of the opportunity to leave early and resell their vacated seats or space, including reminders of any venue or third party inducements offered for leaving early exits. Venue inducements are at the discretion of the venue alone. Notifications may also include the announcement of a bid from a Late Arrival seeking entrance to the event.

In one embodiment, the system proposes a suggested price to ticket holders at which they should consider vacating their seats and posting their seat or space as being available. This is the initial ask price and is set algorithmically based on, or as a function of, one, some or all of the following inputs:
(a) Whether the event is sold out (Higher demand correlates to a higher proposed initial price);
(b) Number of other system users in the venue who have identified themselves as being potential early exits (Less interest in correlates to a higher proposed initial price);
(c) Number of potential late arrivals (More interest correlates to a higher proposed initial price);
(d) Weather at the time of the event;
(e) The score of the event if it is a sporting event; and
(f) Time left in the event (More time remaining) correlates to a higher proposed initial price)
(g) As the event continues, the algorithm to create the suggested selling price may also incorporate as variable the number of transactions for the same event that have closed within the last 5 minutes.

The ticket holder may also be able to override the suggested price and input any price they desire within system and event level parameters.

The system enables any ticket holder who has left a predetermined geolocation boundary or geofence for a certain amount of time or distance from geofence, to be notified of opportunity to post their tickets. This early exit may be done actively through the RFID wristband scanning at a kiosk or through any venue or event ticketing or access control system.

Early Exits may be identified and messaged through integration with a venue's ticketing and access control system, and/or through any and all geolocation technology including geofencing, GPS, beacons, etc. that can be utilized to detect a user's entrance and egresses from a venue. Data captured on Early Exits may include Gate location of exit, time of exit, direction of exit and location heading next.

Concurrently during events, potential buyers (late arrivals) are sent notifications as seats and space are vacated and tickets become available that meet their interests and are in their geographic tolerance threshold.

In this way, through prompting via notifications to potential sellers and buyers, the system may continuously and iteratively making the market for tertiary tickets. In alternative embodiments, no notifications are required and all activity occurs as a “pull” by potential sellers and buyers.

The desired embodiments also enable venues to release unused inventory to the tertiary market after a certain cut off period (e.g., the end of half time in a football or basketball game).

### Transaction—Matching of Buyers and Sellers

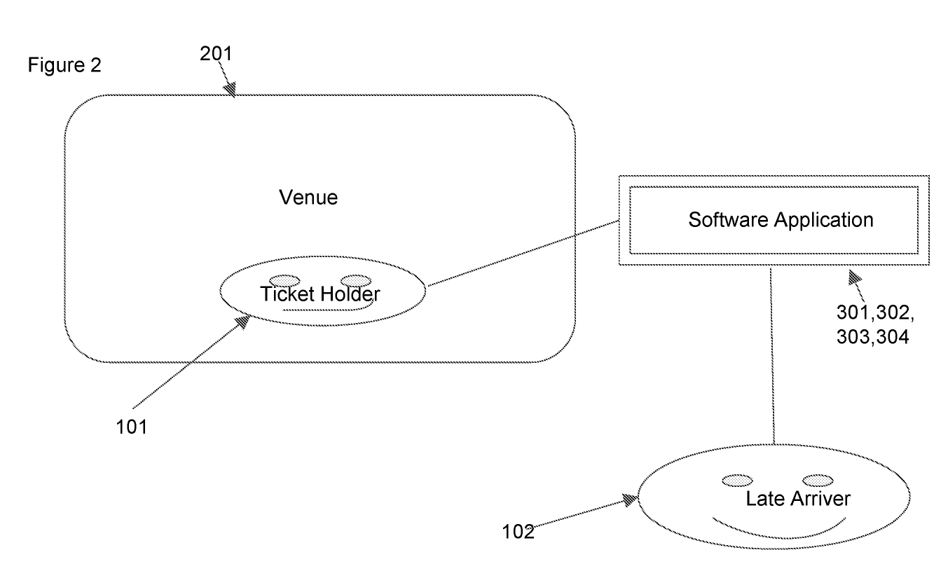

Referring to FIG. 2, tickets made available through the system belong to the initial ticket holder 101 (the “seller” or “early exit”) and will have been redeemed for use at event 201. The method and/or channel through which ticket holder 101 initially obtained the ticket are irrelevant so long as the ticket is valid and can be authenticated inside ticket verification system 305.

The systems and processes described may enable a number of transaction flow variants. Venues may choose which variant to enable. Common to both variants is that:
(a) Users of the system, both early exits and late arrivals, install the application and register for an account before a transaction occurs;
(b) Prospective Early Exits have registered that they hold tickets to an event;
(c) Prospective Early Exits indicate that they have arrived at an event, or the system identifies they have arrived at an event through an integration with the venue or event's ticket or access control system;
(d) Early Exits are prompted to set a minimum price at which they would be willing to sell a ticket; or they are notified of the amount they will receive or inducement they will receive if they leave the event prior to conclusion if a Late Arrival purchase a ticket for their vacated seat or space; and
(e) Late Arrivals are prompted to set a maximum price at which they would be willing to buy a ticket or to select from a listing of tickets at a certain price point, which may be dynamically changing.

A first scenario is a direct, synchronous ticket to ticket transfer from early exit to later arrival. In this scenario the license to use a seat or space is passed directly from seller to buyer.

A second scenario is an asynchronous transfer of the license to use a seat or space at an event whereby the ticket is sold to the late arrival at the same time that the previously issued original ticket is cancelled or deauthorized for entry. In this scenario, the seller and buyer payment processing are asynchronous or close in time.

In both scenarios the flow of system enabled activities may include the following:

User has downloaded app;

User opens app and sees list of events in progress;

User clicks on an event;

User registers for an account if they don't already have one; and

If a ticket is available,
a. The ticket buyer can accept price and complete the transaction, OR
b. They can provide a new bid, OR
c. They can disregard and continue browsing.

A user can purchase multiple tickets and share these tickets with friends or other Users, including possibly through SMS/Email/IM.

A user may link to a webpage the renders a new ticket QR code or registers mobile device for RFID or other mobile technology.

The new entrance ticket code may include branding and sponsor messaging and will preferably have a high error tolerance threshold.

For the early exit, the flow of system enabled activities may be as follows:
(i) The early exiter is notified of a potential price for the ticket sale;
(ii) The inventory is updated to reflect the availability of vacated seats or space; and
(iii) If the early exiter is leaving, they may scan the ticket at the kiosk, via barcode, QR code, or RFID to confirm departure.

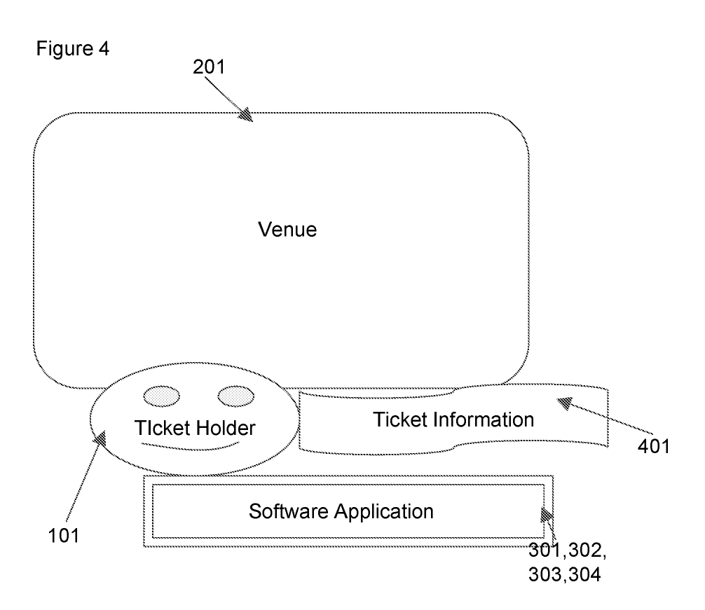

Both scenarios commence with the original ticket holder (the early exit) leaving the event. Referring to FIG. 4, when the ticket holder 101 decides to leave the event 201 before the event is complete, the ticket is made available through the ticket transaction system 301 on the ticket holder's mobile phone 311.

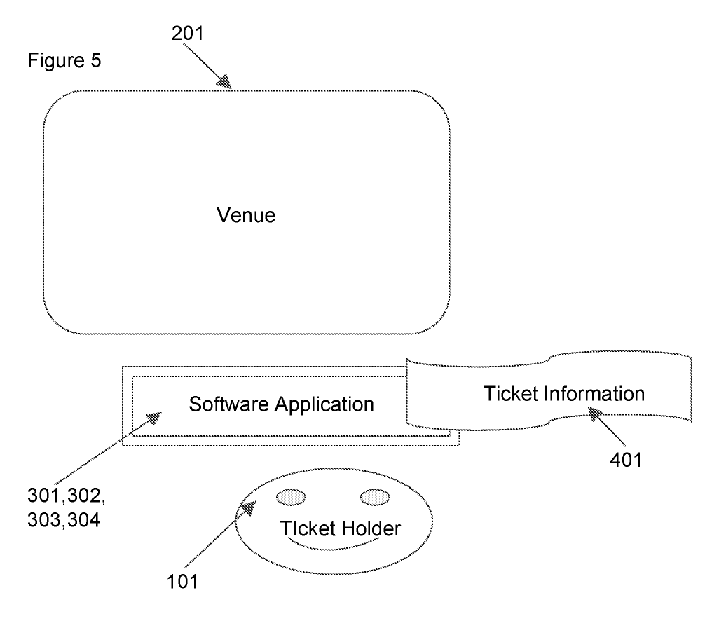

FIG. 5 illustrates a possible procedure for ticket holder 100 to make their vacated seat or space available for resale. Ticket holder 100 will open the software application 300 on the ticket holder's mobile device 310 and look up his ticket information 321 through a process that uses ticket verification system 320. Once the ticket information 321 has been located, the ticket holder associates that ticket with his/her account and marks the ticket as available. Ticket holder then leaves event 200 and the vacated seat or space is then available for purchase.

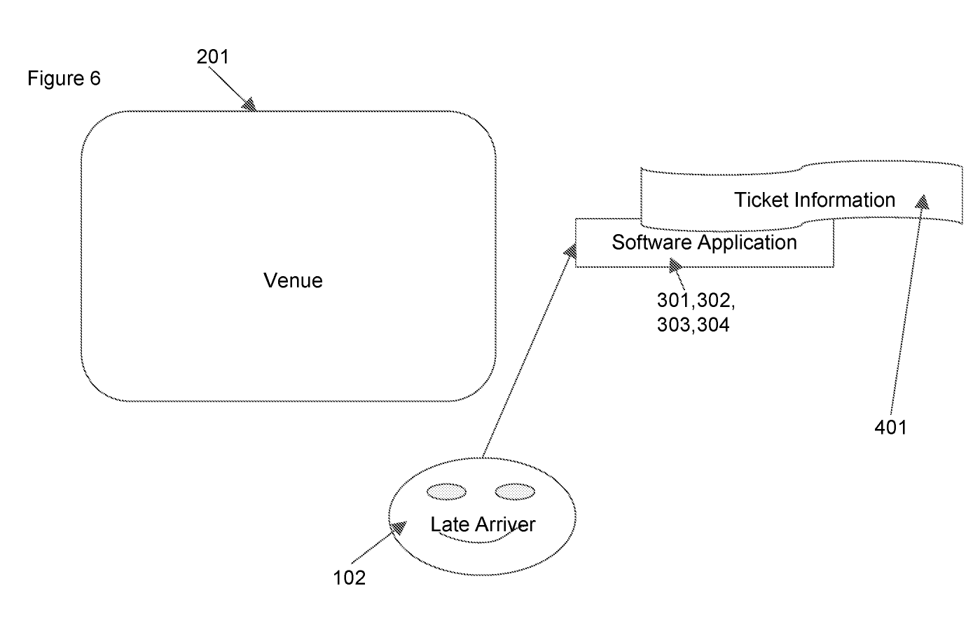

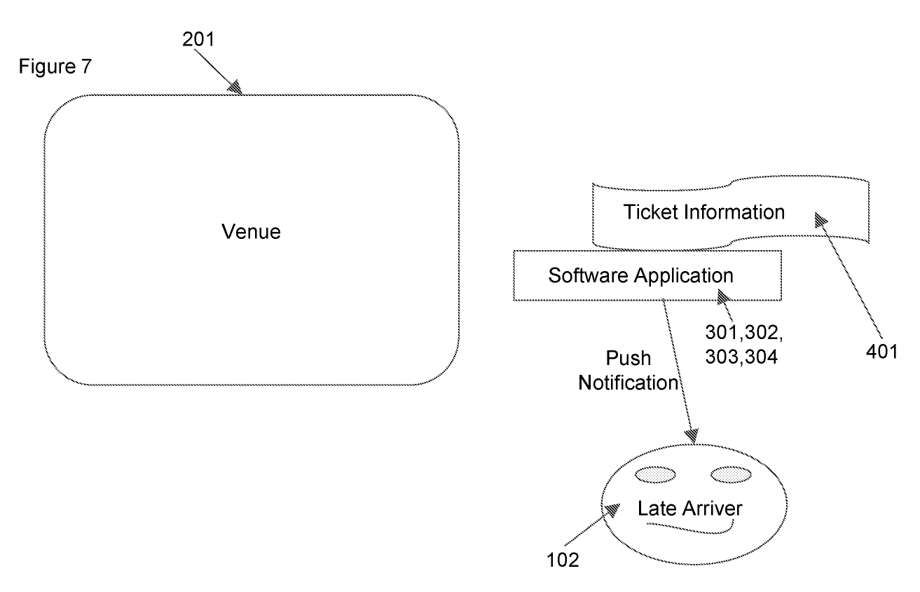

FIG. 6 illustrates that a late arrival may use the software application to locate vacated seats or space made available for resale. FIG. 7 illustrates that the software application may send a push notification to the late arrival of tickets available for events in which they may have interest.

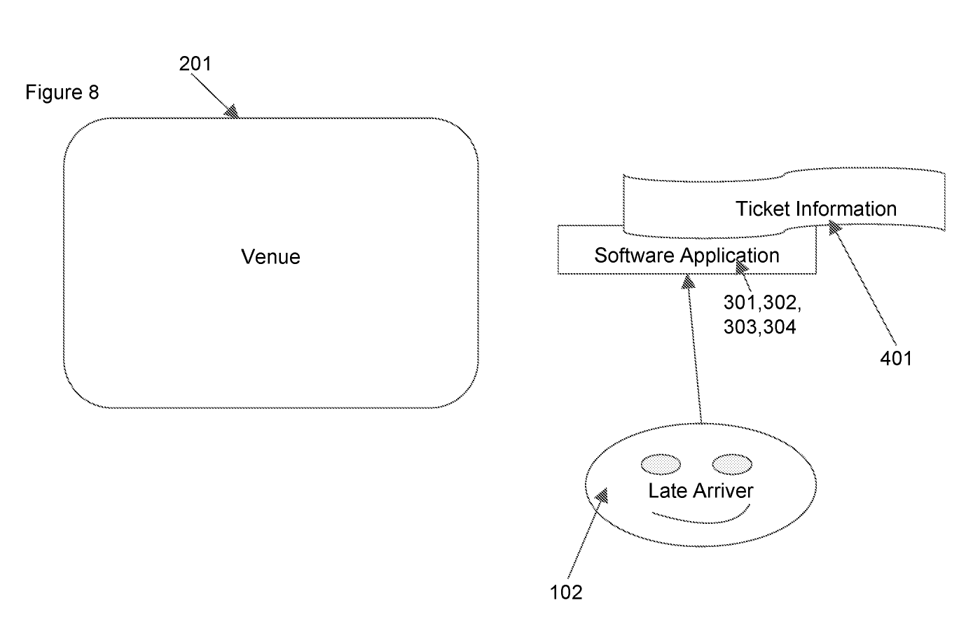

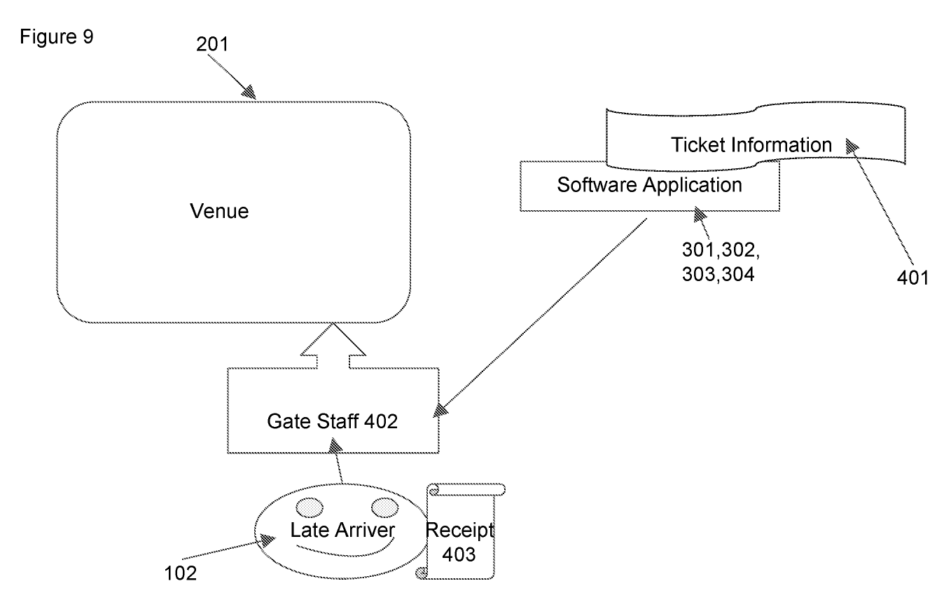

The late arriver may purchase tickets (FIG. 8) through the application and will be allowed entry into the event using the remaining time available on the ticket holder's original purchase (FIG. 9).

### Revenue Model

An exemplary revenue model is based on selling this service as an optional add-on or “upsell” during the initial ticket buying experience. By participating in the service, a ticket buyer can earn back a portion of their purchase price in the event that the depart an event early and a late arriver purchases a ticket for their vacated seat or space. A per ticket or per order fee may be charged as part of the same transaction or a separate, distinct transaction. Any ticket holder who purchases this service is either registered automatically or is provided a notification or link or email to download and register for this service in order to have opportunity to post tickets upon Early Exit.

### Exemplary Process Flows

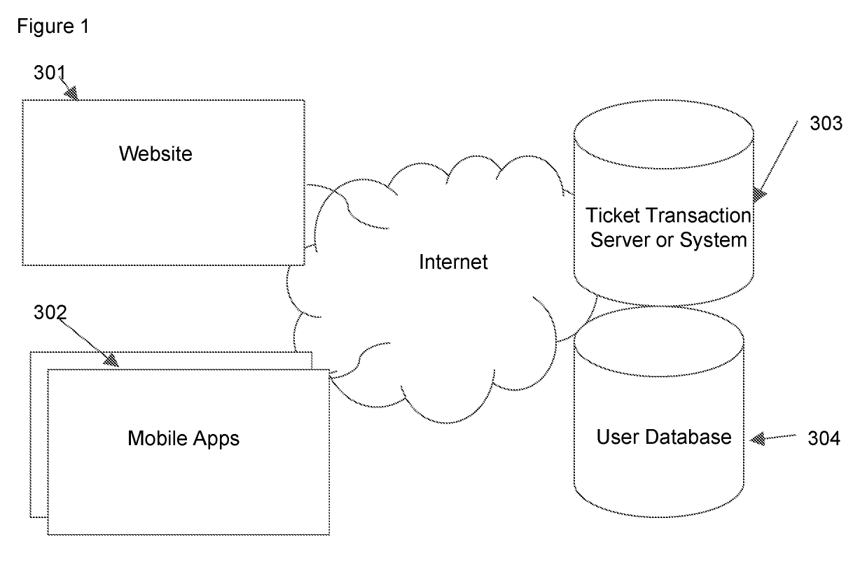

An exemplary process flow of the system can be illustrated with reference to FIGS. 1 through 10. An exemplary system includes mobile apps 302 executing on phones, tablets or other mobile computing devices, a system website 301 and a backend system which may include a ticket transaction system or server 303 and user database 304. The website 301 and mobile apps 302 communicate with the backend system over the internet as shown. The ticket transaction server 303 may communicate with the database 304 over the internet, or can be connected directly or through a local area network, or otherwise.

A User can register with the system as described above either through the mobile app 302 or through the website 301.

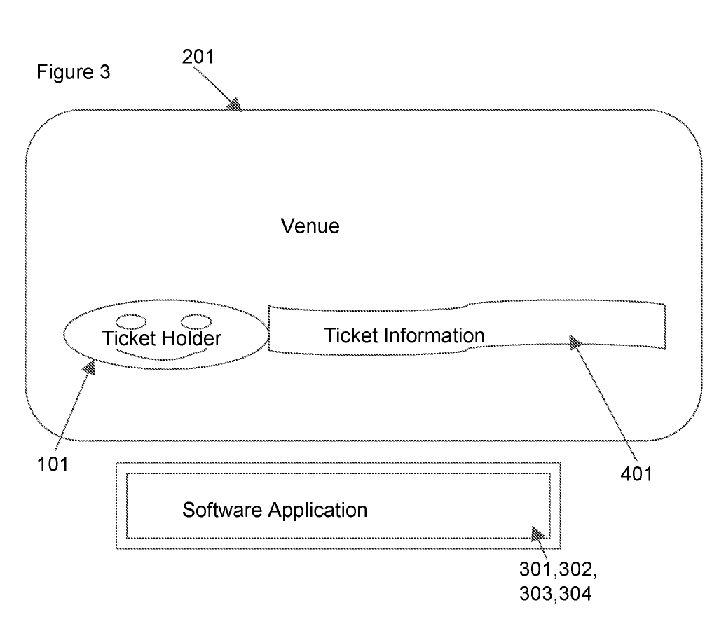

The system software applications 301-304 allow a ticket holder 101 at an event at venue 201 to indirectly connect to a prospective late arriver 102 (FIG. 2). While inside the venue 201, the ticket holder 101 has ownership of the ticket information 401 (FIG. 3). Upon or prior to exit of the venue, the ticket holder 101 will provide ticket information 401 to the software application 301-304 (FIG. 4) or authorize the original ticketing entity to provide the information. For example, the ticket holder 101 may indicate, through the mobile app 301, that they are willing to leave the venue for a given incentive. Once the ticket holder 101 leaves the venue 201, the software application 301-304 takes ownership of the ticket information 401 (FIG. 5). This change in ownership can occur actively, for example by scanning the ticket (paper or electronic) at a kiosk or by a gate agent; or can occur passively, for example using geolocation technologies such as but not limited to GPS, Beacons, ibeacon™ location and proximity detection technology, and other networked and static systems for identifying location of both ticket holder and third party. Change in ownership refers to the right of the software application to offer for sale a ticket for the vacated seat or space. In some instances, the original ticket issuer may create a new ticket and the application will merely be presenting that the new ticket for the vacated seat or space is available for purchase.

A late arriver 102 is able to search for available tickets 401 owned by the software application 301-304 (FIG. 6). Alternatively, or additionally, the software application 301-304 will send a push notification to the late arriver 102 through the mobile app 302 of tickets 401 available for events they're interested in (FIG. 7). Using the mobile app 302, the late arriver 102 can purchase the ticket for the previously occupied seat or space within the software application 301-304. In this regard, the mobile app 302 communicates with the ticketing transaction server 302 to purchase the ticket. When the later arriver 102 arrives at the venue gate, the late arriver 102 will show the electronic receipt 403 on his mobile device to the gate staff 402, and the gate staff 402 will verify that the ticket 401 is valid by communicating with the software 301-304, or an electronic wallet that previously obtained the ticket information from the software, for example, via a computing device (FIG. 9). The electronic receipt, which preferably includes a barcode, serves as a ticket for the resold seat or space. As used herein, a barcode is an optical, machine-readable, representation of data which is sufficient to uniquely identify the ticket to the venue. For example, the barcode could be, for example, linear or matrix barcodes. The gate staff 402 may use a scanner connected to a mobile app to communicate with the ticket transaction server 303 to confirm the validity of the resale ticket.

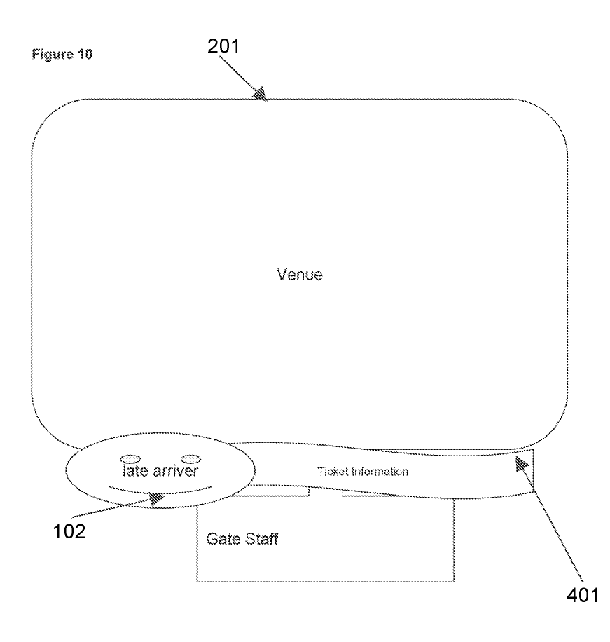

Preferably, only once the purchase is confirmed, does ownership of the ticket information pass to the late arriver (FIG. 10). In this regard, the system can set a time limit on the validity of the late arriver ticket. In this instance, ownership refers to the right of the late arriver to use the ticket to access the previously occupied seat or space. Alternatively, ownership of the ticket information can pass to the late arriver upon purchase.

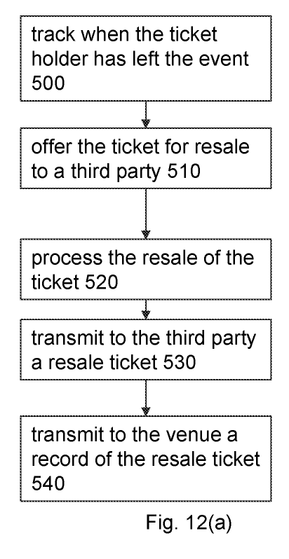

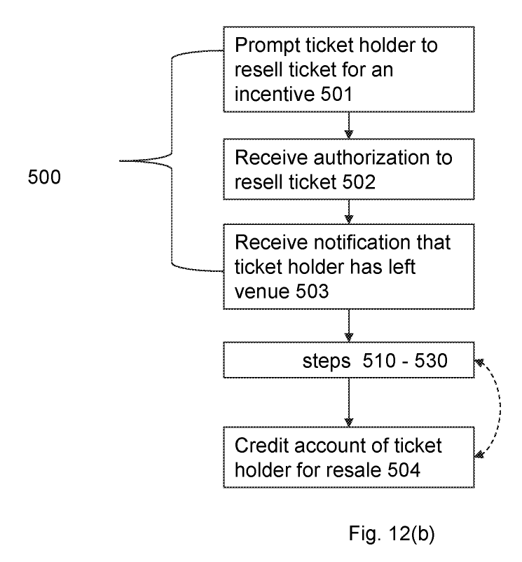

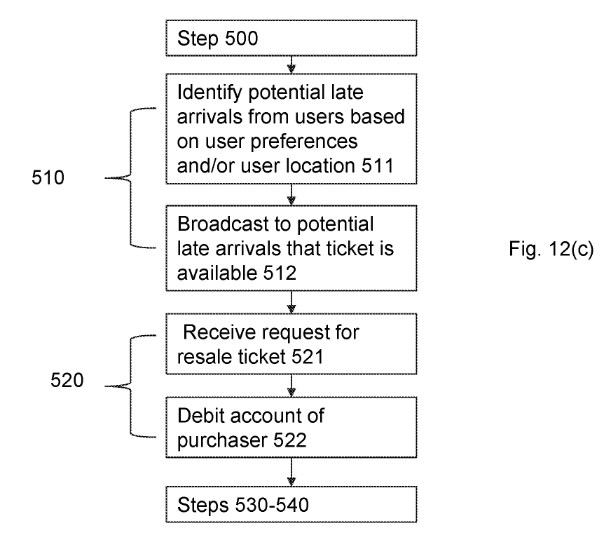

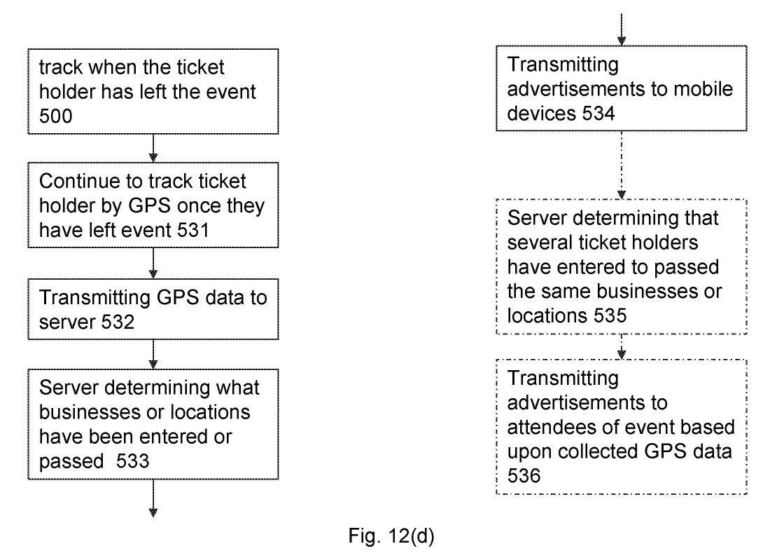

FIG. 12(a) is a flow chat which illustrates process steps in accordance with an embodiment of the present invention. At step 500, while an event is in progress, the system electronically tracks when a ticket holder has left the event. At step 510, the system electronically offers the ticket for resale to a third party. At step 520, the system electronically processes the resale of the ticket, and at step 530, the system electronically transmitting to the third party a resale ticket; and electronically transmits to the venue a record of the resale ticket. Alternatively, a new ticket may be issued representing a resale of the right to occupy the previously vacated seat or space.

Referring to FIG. 12(a), step 500 may include scanning, at an exit of the venue, the ticket, with a hand-held scanning device or scanning kiosk, or through geolocation technologies as described above. Further, referring to FIG. 12(b), in embodiments in which the ticket holder is incentivized to leave the venue and resell the ticket, step 500 may further include prompting the ticket holder to resell the ticket (step 501), which may for example, include a push notification message as shown in FIG. 11G. The method may then include receiving authorization to resell the ticket (step 502), which in turn may include selection of a price through the mobile app 302 (FIG. 11G), and then receiving notification that ticket holder has left venue (step 503), which in turn may for example, include scanning, at an exit of the venue, the ticket, with a hand-held scanning device or scanning kiosk, or through geolocation technologies as described above, followed by transmission of this information to the ticket transaction server 303. The account of the ticket holder is thereafter credited for the resale of the ticket. This crediting preferably occurs after the ticket has been resold to the third party (solid arrow in FIG. 12(b)). However, if the venue or system wishes to provide the incentive independent of any resale to a third party, the ticket holder's account may be credited prior to any resale (dashed arrow in FIG. 12(b)).

Independent of whether or not the embodiment provides incentives for resale, the system may prompt the ticket holder to confirm that they have left the event and are not returning (FIG. 11D).

Referring to FIG. 12(c), step 510 may include, in step 511, identifying potential late arrivals from users based on user preferences, user indication (e.g. FIG. 11F) and/or user location, and broadcasting to potential late arrivals that ticket is available (step 512), for example as shown in FIG. 11C or 11E. Further, step 520 may include receiving a request for an available resale ticket (step 521), for example by sending information sufficient to process the resale from the mobile app 302 to the ticket transaction server 303, and then debiting the account of the late arrival ticket holder for the ticket (step 522), for example, through conventional debit or credit card processing techniques.

Further, referring to FIG. 12(d), when a ticket holder leaves an event in progress, step 500 may further include tracking the ticket holder for a period of time via the GPS function on their mobile device (step 531), transmitting that GPS information to a server (step 532), and then a computer routine on the server determining what businesses or locations that the ticket holder has entered or passed by (step 533). The method may then include transmitting advertisements related to such businesses or locations to the ticket holder's mobile device (step 534), or in addition to, or alternatively, based on data showing that several ticket holders entered or passed by the same businesses or places (step 535), transmitting advertisements to the mobile devices of those still attending the event (step 536), so that those attendees are shown advertisements for businesses or places they are likely to enter or pass by when they leave the event at a later time.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A server for use in a system for providing a market for resale of the right to occupy a previously vacated seat or space upon the departure of a ticket holder from an event while the event is in progress, comprising:
a processor;
computer executable code that in response to receiving a notification that the ticket holder has left the event, transmits an offer to sell a resale ticket for a resale of the right to occupy a previously vacated seat or space to a plurality of mobile apps executing on respective mobile devices of a plurality of prospective buyers that are not in the venue;
computer executable code that upon receiving a request to purchase the resale ticket from one of the plurality of mobile apps, electronically processes the resale ticket; and,
computer executable code that transmits to said one mobile app a resale ticket and electronically transmits to the venue a record of the resale ticket.

2. The server of claim 1, wherein the server receives, from a mobile app executing on a mobile device of the ticket holder, information sufficient to indicate an offer to resell the right to occupy a previously vacated seat or space in return for an incentive; and wherein the server credits an account of the ticket holder with the incentive after the resale is processed.

3. The server of claim 1, wherein the server receives the notification that the ticket holder has left the event from the mobile app executing on the mobile device of the ticket holder.

4. The server of claim 1, wherein the server receives the notification that the ticket holder has left the event from a geolocation system, the geolocation system being one of a geofencing system, a GPS system, and a beacon system.

5. The server of claim 1, wherein the server credits an account of a venue at which the event is held with a remittance after the resale is processed.

6. The server of claim 1, where the server receives a confirmation of the location of the prospective buyer from the mobile app.
